(19) United States
(12) Patent Application Publication
(10) Pub. No.: US 2009/0174168 A1
(43) Pub. Date: Jul. 9, 2009

(54) WHEELCHAIR ADAPTED TO STAIRCASES

(75) Inventors: Panagiotis Pavlopoulos, Saint Jean De La Ruelle (FR); Konstantin-Leo Pavlopoulos, Lyon (FR); Samuel Deberles, Courbervoie (FR)

Correspondence Address: OLIFF & BERRIDGE, PLC, P.O. BOX 320850, ALEXANDRIA, VA, 22320-4850, US

(73) Assignee: HERON TECHNOLOGIES, Orleans (FR)

(21) Appl. No.: 12/293,010

(22) PCT Filed: Mar. 20, 2007
(86) PCT No.: PCT/FR2007/000474

§ 371 Date: Dec. 18, 2008

(30) Foreign Application Priority Data
Mar. 20, 2006 (FR) 0602410

(51) Int. Cl. B62M 1/14

(52) U.S. Cl. 280/250.1

(57) ABSTRACT

The invention concerns a wheelchair (1) comprising: a chassis (2) supporting a seat; two rear wheels (4) of large diameter, mobile relative to the chassis between a low position for normal use and a raised position for climbing a staircase, an auxiliary drive mechanism for climbing a staircase.

This invention relates to a wheelchair equipped with an additional propulsion mechanism enabling it to go up and down stairs.

There are two categories of people who use wheelchairs to move about, namely those who move about with difficulty and cannot on their own easily use wheel-chairs, and those who are generally younger and more active, who move about on their own and have an imperative need for autonomy and independence.

This latter category is capable for example of getting from the wheelchair to a vehicle seat and vice versa and putting the wheelchair in the vehicle without external help.

The wheelchair must therefore be as light as possible while satisfying ergonomic requirements and meeting the applicable regulations, and must if required allow the large rear wheels to be removed so that the chair can be placed on the passenger seat or behind the front seat.

It is also desirable for the wheelchair to be foldable to save space when not in use.

Many countries make it a legal requirement to provide access ramps for people in wheelchairs. This requirement is not however always complied with, and even when it is, there may be situations where there are steps before the ramp. In many locations access for people in wheelchairs is thus often very difficult and they are forced to get help from other people.

A number of quite complicated and heavy wheelchairs that have four sets of independent feet with numerous electric motors already exist. Such wheelchairs are comfortable for the user when negotiating stairs but are intended only for going up and down stairs and are therefore incompatible with habitual use of a conventional wheelchair.

Another type of known wheelchair comprises a device similar to a handling trolley which goes on the back of the wheelchair. This device requires the intervention of a third party.

U.S. Pat. No. 4,512,588 discloses a wheelchair capable of negotiating staircases using the motive power of the user only. This wheelchair is of comparatively complicated design, with no large rear wheels, which are replaced by several wheels mounted on a rotary support.

French patent application FR 2 648 038 discloses a wheelchair comprising an additional propulsion mechanism designed to be driven by the user. This additional propulsion mechanism comprises racks which are moved in a relatively complicated way to engage with the steps of the staircase.

There is a need for a wheelchair that can be used in daily life for its conventional function and which benefits from an auxiliary propulsion system which will enable its user to negotiate staircases, if possible with minimal effort from the user.

It is an object of the invention to overcome all or some of the drawbacks of the prior art by providing a wheelchair that works reliably, is of robust construction, is easy to use and ergonomic, keeps the user completely safe, and can easily be handled by the user, particularly for loading into a motor vehicle without external assistance.

In one of its aspects, the subject of the invention is a wheelchair comprising:
a frame supporting a seat,
two large-diameter rear wheels that are movable relative to the frame between a low position for normal use of the wheelchair and a raised position for negotiating a staircase and
an auxiliary propulsion mechanism for negotiating a staircase, comprising
   front and rear load-supporting elements configured to bear on the steps of the staircase when the rear wheels are in the raised position and the wheelchair has its back to the slope of the staircase, the front load-supporting elements and rear load-supporting elements rotating about separate axes of rotation, and
   a transmission system for transmitting a rotation from the large rear wheels in the raised position to the load-supporting elements in order to turn the latter and cause the wheelchair to move up or down the staircase, depending on the direction in which the large rear wheels are turned.

The raising of the large rear wheels can be accompanied by a downward and rearward movement of the user's center of gravity in the seat. This increases the stability, makes the journey up or down the staircase more comfortable, and can reduce the user's apprehension.

The raising of the large rear wheels also means that they do not interfere with the progress of the wheelchair along the stairs.

The invention ensures that the wheelchair will not fall accidentally, even if the user becomes unconscious while the stairs are being negotiated.

The tilting of the seat can enable the user more easily to maintain an upright posture while on the stairs.

The large rear wheels may for example move from the lowered position to the raised position at the end of an angular travel of greater than or equal to 45°, at the end of an upward movement of for example greater than or equal to 8 cm in the case of a 60° travel and at the end of a forward movement of for example greater than or equal to 4 cm in the case of a 60° travel.

The distance between the axis of rotation of the front load-supporting elements and the axis of rotation of the large rear wheels in the stairclimbing configuration is greater than or equal to 70 cm, preferably greater than or equal to 75 cm, and the distance between the axis of rotation of the large rear wheels and the axis of rotation of the rear load-supporting elements is greater than or equal to 50 cm, in the stairclimbing configuration.

This latter distance may be for example about 46 cm in the configuration of normal use of the wheelchair.

The rear load-supporting elements may be mounted rotatably on the frame, being synchronous in rotation with the front load-supporting elements.

The large rear wheels may be detachable.

The wheelchair may comprise at least one structure that pivots relative to the frame about an axis of rotation, movement of at least one large rear wheel from the low position to the raised position and vice versa being effected by a rotation of the pivoting structure.

The auxiliary propulsion mechanism may comprise a transmission system constructed so as to gear down a force applied to the large rear wheels in the raised position in order to turn the load-supporting elements. As a result, even a user who does not have very strong arms can easily negotiate a staircase.

The auxiliary propulsion mechanism may comprise at least one first drive element and the large rear wheels may rotate with at least one second drive element, this second drive element coming into driving engagement with the first drive element only when the large rear wheels are in the raised position. This may allow the additional propulsion mechanism to be engaged only when the large rear wheels are moved to the raised position.

The auxiliary propulsion mechanism may comprise left-hand and right-hand submechanisms, the left-hand submechanism being connected to the left-hand front and rear load-supporting elements and to the left-hand large rear wheel and the right-hand submechanism being connected to the right-hand front and rear load-supporting elements and to the right-hand large rear wheel.

The left-hand and right-hand submechanisms may be connected by a coupling shaft so that the rotation of the left-hand and right-hand load-supporting elements is synchronous This coupling shaft may be foldable, retractable or removable, in order not to interfere with the folding of the frame, where the latter is foldable in the direction of the width.

Each large rear wheel may be supported by a structure that pivots relative to the frame, preferably removably to simplify the handling of the wheelchair.

The pivoting structure may comprise for example at least one lever operable by a user sitting in the seat and which, when operated, moves the large rear wheels from the low position to the raised position and vice versa. In a variant, the pivoting structure may be turned by a screw drive mechanism such as a screw turned by a crank, or by a pneumatic or hydraulic mechanism, or may be driven by an electric motor.

The wheelchair may comprise two pivoting structures, one connected to the left-hand submechanism and the other to the right.

The wheelchair may comprise a system for locking the pivoting structures in the positions corresponding respectively to the raised position of the large rear wheels and the lowered position of the large rear wheels. This locking system may comprise, for example, a button for unlocking the pivoting structure built into the aforementioned control lever.

Each pivoting structure may comprise front and rear bars carrying the corresponding large rear wheel and a front load-supporting element, respectively. The aforementioned control lever may be connected between the bars near to the axis of rotation of the pivoting structure.

The front bar carrying the front load-supporting element may be retractable both so as to reduce the size of the additional propulsion mechanism when the wheelchair is in normal use and so as not to interfere seriously with the sideways transfer of the person sitting in the wheelchair to another seat.

The load-supporting elements may comprise crosses, and each cross may comprise four arms approximately perpendicular to each other.

The dimensions of each arm, at its distal end, measured at right angles to the axis of rotation of the large rear wheels, may be relatively large, to increase the stability of the wheelchair on the steps.

In an illustrative embodiment of the invention, the movement of the large rear wheels from the lowered position to the raised position is done manually, without motorized assistance. The large rear wheels, in the raised position, may also be turned without motorized assistance.

Each submechanism may comprise a primary transmission shaft for transmitting a rotation of the large rear wheel connected to the corresponding front and rear load-supporting elements.

The primary transmission shaft may comprise two sets of teeth connected by transmission elements to corresponding sets of teeth rotating with the front and rear load-supporting elements, respectively. These transmission elements may be chains or belts, for example, or may comprise at least one secondary transmission shaft, optionally incorporating at least one universal joint. This secondary transmission shaft may be retractable, if desired, so that the front load-supporting elements can be closed up toward the large rear wheels to reduce the size of the wheelchair during normal use.

The primary transmission shaft may rotate with a third set of teeth and mesh with an intermediate pinion. The corresponding large rear wheel may have an associated set of teeth in order, when the large rear wheel is in the raised position, to engage with the intermediate pinion in such a way as to transmit the rotary movement of the large rear wheel to the load-supporting elements.

The invention also relates to a wheelchair comprising a frame supporting a seat and capable of negotiating an obstacle by means of at least one rotary load-supporting element, this rotary load-supporting element making it possible to negotiate successive approximately planar levels, such as the steps of a staircase, being capable, in the course of its rotation, of standing first on a first planar level and then on both the first level and the next level simultaneously. This rotary load-supporting element may be cross-shaped with at least two arms whose distal ends are capable of resting on two successive steps or levels. The wheelchair may comprise four rotary load-supporting elements, two on each side of the frame, each in the form of a cross with four arms. The front load-supporting elements may be retractable with operating means for retracting and/or extending them. The wheelchair propulsion means may be capable of engaging with transmission means in order to turn the rotary elements. These transmission means may be two drive shafts and a coupling shaft, the drive shafts being capable of engaging with pinions and chains or belts as well as with toothed wheels and gear trains in order to produce rotational speed reduction. The transmission means may be any other means capable of transmitting the rotation of the rear wheels in order to perform the stairclimbing function of the wheelchair so as to negotiate an obstacle.

When the large rear wheels are lowered, the additional propulsion system does not interfere with the normal use of the wheelchair.

The frame may comprise tubular structures forming the skeleton of the seat, retaining means of for example parallelepiped general shape to act as reinforcements on each side of the wheelchair, and supporting means to take the weight of the user and keep the wheelchair in a functioning configuration. The frame may comprise lattice work or spiders, which may be foldable through having screws or any other pivot means, for example in their center.

The length of the control levers may be greater than the length of the front bars.

The pivoting structure may be indexed rotationally by any means that allows the angles of the pivoting structure corresponding variously to the lowered and raised positions and of the large rear wheels to be fixed, the angles being calculated for the normal function of the wheelchair and for the stairclimbing function.

In a variant, the two pivoting structures may be connected together in such a way that tilting one of the pivoting structures causes the other pivoting structure to tilt also.

For every revolution of the rear wheel, the loads supporting elements rotate for example one quarter of a revolution. A locking system may be provided in case the user stops applying effort while traveling up or down the stairs. This is to keep the wheelchair stationary without any possibility of it tilting or descending uncontrollably.

The invention may be easier to understand on reading the following detailed description of certain non-restrictive illustrative embodiments thereof, and on examining the appended drawing, in which:

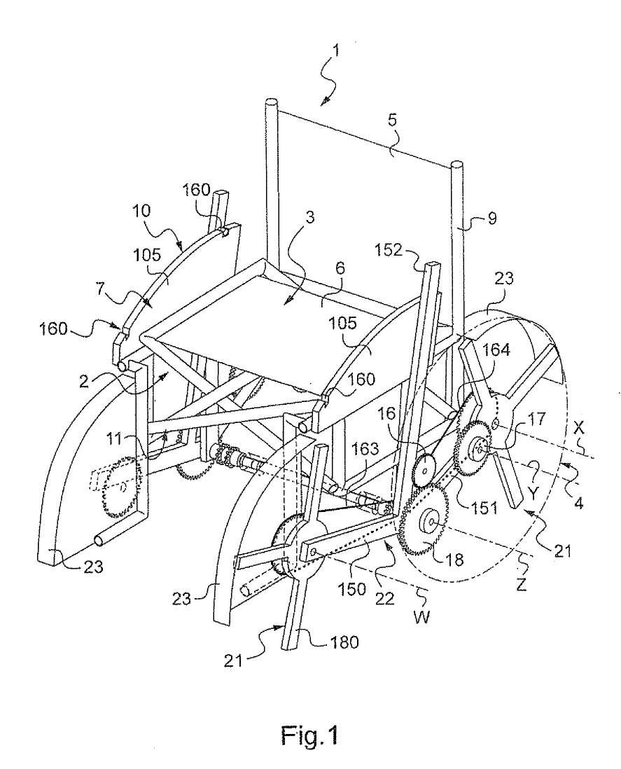

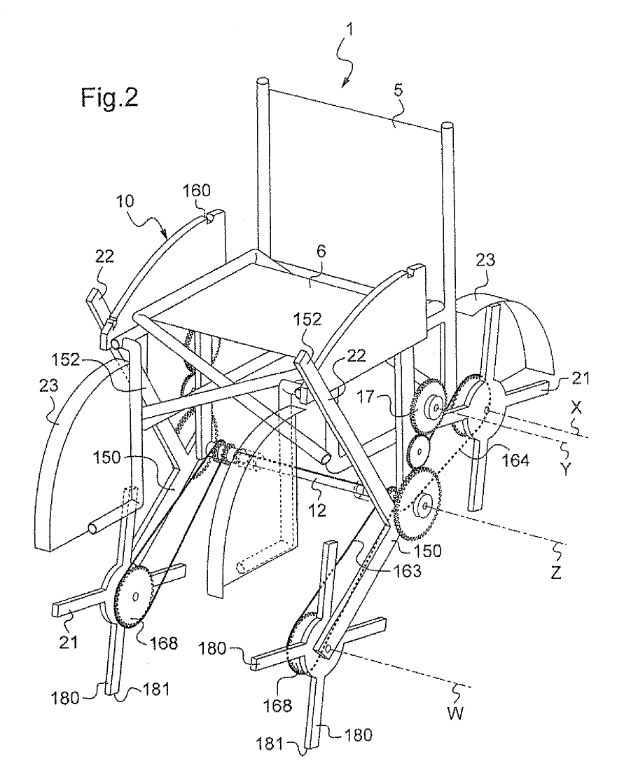

FIGS. 1 and 2 are schematic partial views in perspective of an illustrative embodiment of a wheelchair according to the invention, the large rear wheels being in the lowered and raised positions, respectively,

FIG. 3 illustrates an example of the positioning of a load-supporting element on a consecutive step,

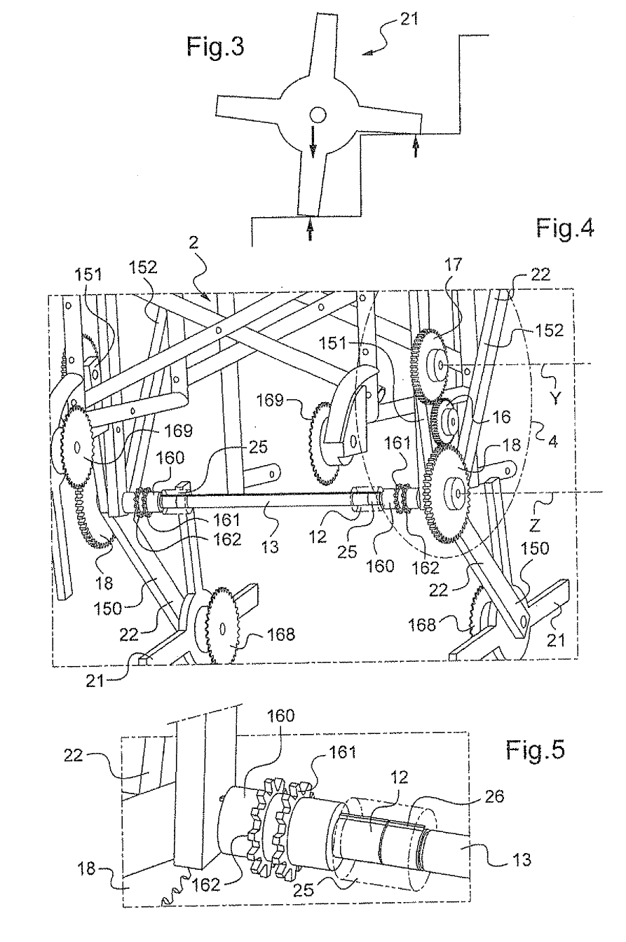

FIGS. 4-7 illustrate various details of the embodiment of the wheelchair shown in FIGS. 1 and 2,

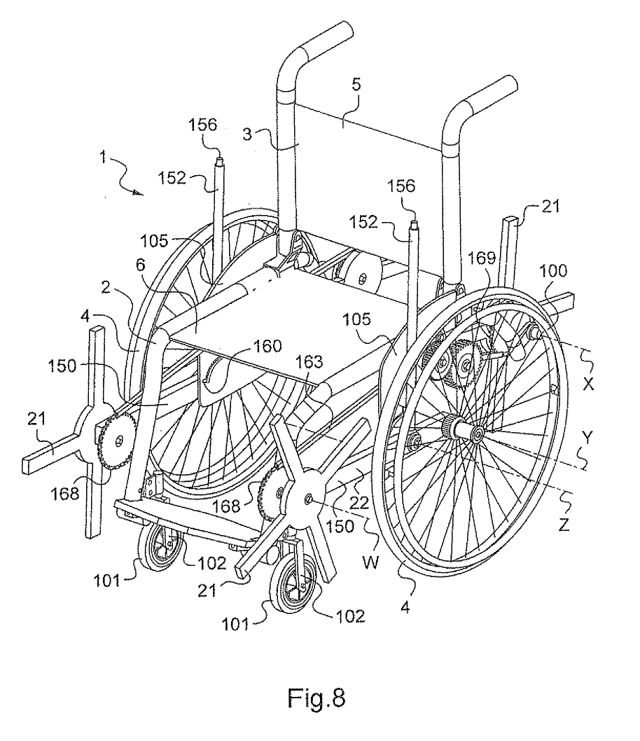

FIG. 8 shows schematically in perspective another illustrative embodiment of the wheelchair,

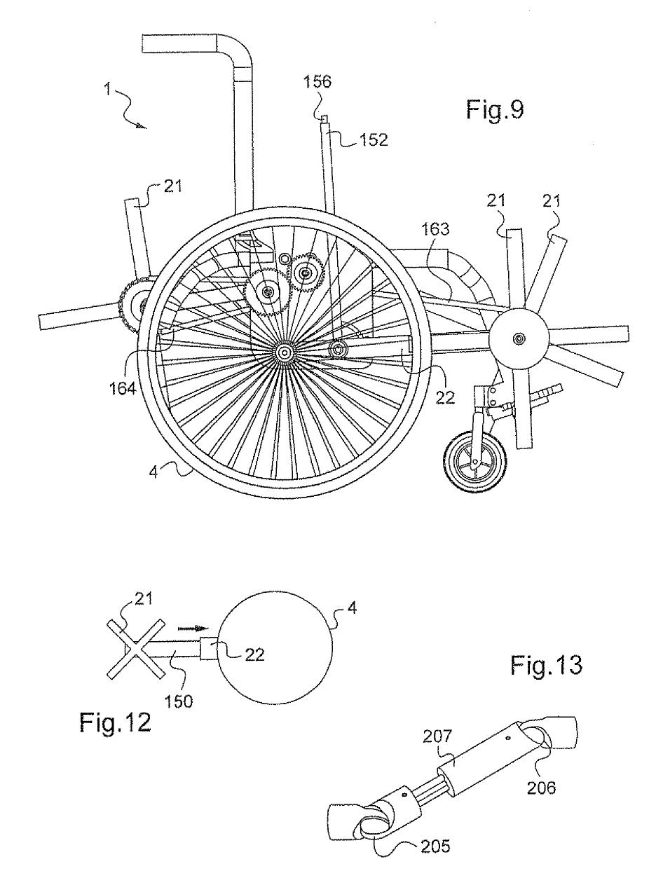

FIG. 9 shows the wheelchair from FIG. 8 in a side view,

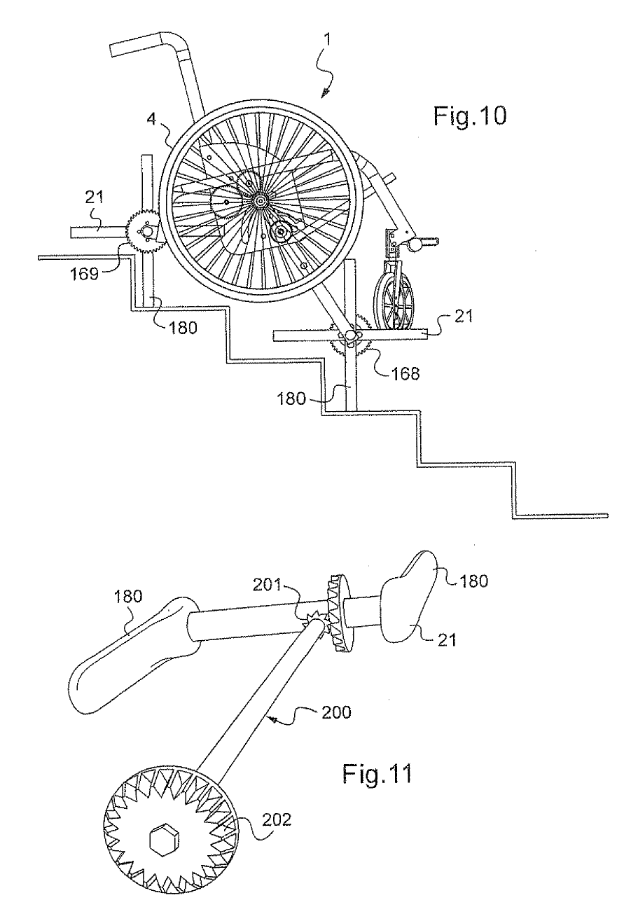

FIG. 10 illustrates the use of the auxiliary propulsion system of the wheelchair from FIGS. 8 and 9 for climbing or descending steps,

FIGS. 11 and 13 show variants of means for transmitting the movement from the large rear wheels to the load-supporting elements, and

FIG. 12 shows the connection of a front load-supporting element to a retractable bar.

The wheelchairs 1 shown in FIGS. 1, 2 and 8 comprise a frame 2 supporting a seat 3.

As is conventional, the wheelchair 1 has two large rear wheels 4, each provided with a handrail 100 visible in FIG. 8 and two small front wheels 101, also visible in this figure, which may be carried by forks 102 pivoting about axes which may be vertical.

The wheelchair may have a footrest as can be seen in FIG. 8.

The seat 3 has a backrest 5 and an approximately horizontal seat 6. The backrest 5 and the horizontal seat 6 may be made of textile material or any other material suitable for supporting the user and foldable so as to fold with the frame 2 when required.

The frame 2 has a framework supporting the seat 3 and upright sidepieces 105 to act as armrests if required.

The frame 2 is advantageously constructed so as to be foldable. It is folded by moving the large rear wheels 4 toward each other.

The framework of the frame 2 may comprise for example two side structures that can be pushed toward each other to fold the chair by virtue of having a hinged structure, which may comprise elements forming a lattice work hinged to each other.

The large rear wheels 4 may be detachable.

The frame 2 may advantageously allow the ergonomic adjustments of conventional hand-propelled wheelchairs.

The wheelchair 1 comprises an auxiliary propulsion mechanism for the staircase climbing/descending function. This auxiliary propulsion mechanism comprises two front rotating load-supporting elements 21 and two rear rotating load-supporting elements 21, one of each on both the left- and right-hand sides of the frame.

The rear load-supporting elements 21 are mounted rotatably on the frame about an axis of rotation X situated for example very slightly behind the seat 3, parallel to the axis of rotation Y of the large rear wheels 4. The pivoting structure may for example be mounted rotatably on structural elements of the frame 2 forming retaining means for the horizontal seat. The rear rotating load-supporting element may be mounted rotatably on for example a side structure of the frame.

The left- and right-hand front load-supporting elements 21 are mounted on respective left- and right-hand pivoting structures 22 which rotate about an axis of rotation Z parallel to the X and Y axes.

In the example considered, each pivoting structure 22 comprises a front bar 150 and a rear bar 151. These are hinged about the Z axis.

Each structure 22 can be rotated by means of for example a control lever 152 connected to the bars 150 and 151 near to the z axis.

The rear bar 151 carries the corresponding large rear wheel 4, preferably in such a way as to allow it to be raised.

The control lever 152 can pivot between two positions shown variously in FIGS. 1 and 2, corresponding to the lowered position of the large rear wheels 4 and to their raised position.

The pivoting structures 22 can be locked in the raised and lowered positions by various means, for example by engagement between the control lever 152 and the frame 2, for example between the control lever 152 and an upright sidepiece 105.

As can be seen more precisely in FIG. 8, the control levers 152 may each have a locking pin engageable in notches 160 provided on a corresponding upright sidepiece 105. Unlocking may be done for example by means of a pushbutton 156 on the end of the control lever 152, which the user can depress to move or retract the locking pin to allow the pivoting structure to pivot about the Z axis.

The additional propulsion mechanism of the wheelchair 1 comprises two submechanisms, one on the left side and one on the right side of the wheelchair.

Each submechanism comprises, as can be seen particularly in FIG. 4, a primary drive shaft 160 which in this example has first and second sets of teeth 161 and 162.

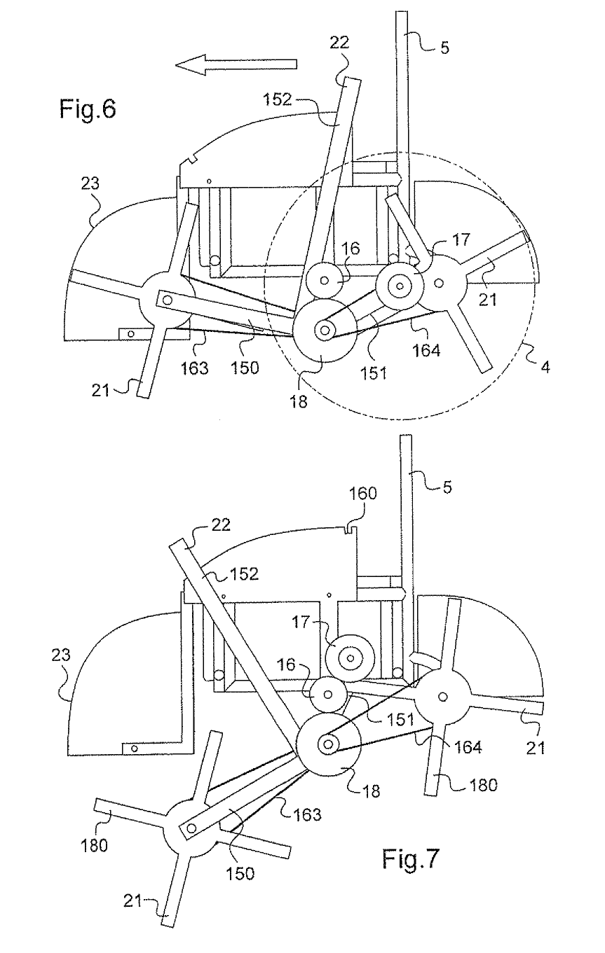

The sets of teeth 161 and 162 are respectively connected by chains 163 and 164, as can be seen particularly in FIGS. 6 and 7, to toothed wheels 168 and 169 turning respectively with the front and rear load-supporting elements 21.

The primary drive shaft 160 rotates with a drive element 18, which may for example be a toothed wheel, meshing with an intermediate drive element 16, which may for example also be a toothed wheel, as can be seen in FIG. 4.

The large rear wheels 4 rotate with drive elements 17 which may for example be toothed wheels.

When the large rear wheels 4 are in the lowered position, as shown in FIG. 6, the large rear wheels can rotate independently of the additional propulsion mechanism because the drive element 17 is not engaged on the intermediate drive element 16.

When the large rear wheels 4 are raised, as shown in FIG. 7, the drive element 17 comes into driving engagement with the intermediate drive element 16, with the result that the rotation of the large rear wheels is transmitted to the primary transmission shaft 160, which in turn drives the load-supporting elements 21 via the chains 163 and 164. The latter are not shown in FIG. 4 for the sake of clarity of the drawing.

Rotation of the front load-supporting elements 21 takes place about an axis of rotation W parallel to the axis of rotation X of the rear load-supporting elements 21.

The various drive elements which interact to transform the rotation of the primary transmission shaft 160 into a rotation of the front and rear load-supporting elements 21 are arranged in such a way that the rotation of the load-supporting elements 21 is synchronous.

In addition, in the example illustrated, the primary transmission shafts 160 of the left- and right-hand submechanisms are connected by a coupling shaft 13, in such a way that the rotation is synchronous between the left- and right-hand load-supporting elements 21. The right- and left-hand submechanisms may for example be identical. The primary transmission shafts 160 may be connected to the coupling shaft 13 via sleeves 25 which may be indexed rotationally by keys or pegs 26.

In the example shown, the load-supporting elements 21 each form a cross with four arms 180 arranged perpendicularly to each other.

The distal end 181 of each arm 180 is situated at a distance from the axis W that is greater than or equal to the height of the step to be negotiated.

The length of an arm 180 may for example be greater than or equal to the height, and half the length, of a step of the staircase.

FIG. 3 shows how the distance between the end of an arm and the axis of rotation W can be slightly greater than the step height.

The load-supporting element may optionally rest in a balanced manner on two points, thereby increasing the stability of the wheelchair.

The load-supporting elements 21 may be protected by housings 23, as illustrated in FIGS. 1 and 2.

The front and rear load-supporting elements 21 are preferably arranged so that the arms 180 are parallel to each other when the wheelchair is in the stairclimbing configuration, as illustrated in FIG. 10.

To use the wheelchairs depicted in FIGS. 1 and 10, the user takes up a position with his or her back to the slope and pushes on the control levers 152 in such a way as to raise the large rear wheels 4. Their raising is accompanied by an upward and forward movement of the large rear wheels and by a lowering of the seat 3, the consequence of which is to move the center of gravity of the user to a position in which the stability of the wheelchair is increased and in which the user is securely cradled in the bottom of the seat and thus has less apprehension about climbing or descending the stairs.

Owing to the position of the user in the example in question, more than one half of the weight of the user, for example two thirds of the weight of the user, can be supported by the two rear rotating load-supporting elements. This can contribute to safety and stabilize the wheelchair when climbing or when descending to the previous step if the user relaxes his effort. Safety is augmented by having wide arms, because the wider the arms the more the wheelchair will resist pivoting of the load-supporting elements. The front load-supporting elements may have wider arms than the rear load-supporting elements in order to increase the torque required for the movement, while also ensuring the safety of the user.

The user can turn the large rear wheels by using the handrails in the direction corresponding to climbing or descending the stairs.

Each submechanism of the additional propulsion mechanism gears down the rotation of the large rear wheels 4, which means that the user has to supply only a moderate effort to be able to negotiate a staircase.

Having successfully negotiated the staircase, the user can resume the configuration of normal use of the wheelchair by pulling up the control levers to lower the large rear wheels. This lowering of these wheels is accompanied by a disconnection of the transmission between the large rear wheels and the load-supporting elements.

Clearly, the invention is not limited to the examples described.

In particular, numerous modifications may be made to the frame and to the additional propulsion mechanism.

As seen in FIG. 11 in particular, a load-supporting element 21 can be turned using a secondary drive shaft 200 which may for instance have bevel gears 201 and 202 at either end, to turn the drive line through 90°.

If desired, as illustrated in FIG. 12, the front bar 150 which supports the front load-supporting element 21 may be longitudinally retractable over a distance of for example greater than or equal to 20 cm, for example about 25 cm, so that the front load-supporting element 21 can be moved toward the large rear wheel 4 to facilitate sideways movement of the person sitting in the wheelchair onto another seat.

The front bar 150 may comprise two rectangular sections sliding one inside the other, or a foldable shaft.

To enable the front bar 150 to be retracted there may for example be a secondary transmission shaft as illustrated in FIG. 13, comprising for example two universal joints 205 and 206 connected by a retractable portion 207.

The control levers 152 can be replaced by other means of driving the pivoting structures, such as a screw mechanism driven by a crank, the crank being positioned for example behind the top edge of the upright sidepieces 105.

The screw may engage in a nut fixed to the associated pivoting structure, so that the screw can be rotated in either direction to lower or raise the pivoting structure 22. The screw may if desired have a function of locking the associated pivoting structure in the raised or lowered position.

In other variants, the chains are replaced with a closed hydraulic system in which a pump is operated by the rotation of the large rear wheels and by the hydraulic motors turning the load-supporting elements.

To store the wheelchair 1, the frame, particularly the parts connecting the side structures, may for example fold up. The sleeves 25 may slide in order to release the coupling shaft 13 connecting the submechanisms.

The coupling shaft 13 may be removable or foldable by means of for example a hinge at its center with an axis perpendicular to the Z axis.

The expression “comprising a” should be interpreted as synonymous with “comprising at least one”, unless the contrary is stated.

A variety of constructional details may be combined for variants that are not illustrated.

The rotary driving of the large wheels may be assisted electrically, if required, as may the pivoting of the pivoting structures supporting the front load-supporting elements and the large rear wheels.

1. A wheelchair comprising:
a frame supporting a seat,
two large-diameter rear wheels that are movable relative to the frame between a low position for normal use of the wheelchair and a raised position for negotiating a staircase, and
an auxiliary propulsion mechanism for negotiating a staircase, comprising
front and rear load-supporting elements configured to bear on the steps of the staircase when the rear wheels are in the raised position and the wheelchair has its back to the slope of the staircase, the front load-supporting elements and rear load-supporting elements rotating about separate axes of rotation (X, W), and
a transmission system for transmitting a rotation from the large-diameter rear wheels in the raised position to the load-supporting elements in order to turn the latter and cause the wheelchair to move up or down the staircase, depending on the direction in which the rear wheels are turned.

2. The wheelchair as claimed in claim 1, the rear wheels being carried by at least one structure that pivots relative to the frame about an axis of rotation (Z), movement of the rear wheels from the low position to the raised position and vice versa being effected by a rotation of the pivoting structure.

3. The wheelchair as claimed in claim 1, the auxiliary mechanism comprising a transmission system constructed so as to gear down a force applied to the rear wheels in the raised position in order to turn the load-supporting elements.

4. The wheelchair as claimed in claim 1, the auxiliary mechanism comprising at least one first drive element and the rear wheels rotating with at least one second drive element, this second drive element coming into driving engagement with the first drive element only when the rear wheels are in the raised position.

5. The wheelchair as claimed in claim 1, the auxiliary mechanism comprising left-hand and right-hand submechanisms, the left-hand submechanism being connected to the left-hand front and rear load-supporting elements and to the left-hand large-diameter rear wheel and the right-hand submechanism being connected to the right-hand front and rear load-supporting elements and to the right-hand rear wheel.

6. The wheelchair as claimed in claim 5, the left-hand and right-hand submechanisms being connected by a coupling shaft so that the rotation of the left-hand and right-hand load-supporting elements is synchronous.

7. The wheelchair as claimed in claim 1, each rear wheel being supported by a structure that pivots relative to the frame.

8. The wheelchair as claimed in claim 7, the structure comprising at least one control lever operable by a user sitting in the seat and which, when operated, moves the rear wheels from the low position to the raised position and vice versa.

9. The wheelchair as claimed in claim 7, comprising a system for locking the pivoting structures in the positions corresponding respectively to the raised position of the rear wheels and the lowered position of the rear wheels.

10. The wheelchair as claimed in claim 7, in which each pivoting structure comprises a rear bar carrying the corresponding rear wheel and a front bar carrying a front load-supporting element.

11. The wheelchair as claimed in claim 8, in which the control lever is connected between the bars near to the axis of rotation (Z) of the structure.

12. The wheelchair as claimed in claim 1, in which the rear load-supporting elements are mounted rotatably on the frame.

13. The wheelchair as claimed in claim 6, in which the coupling shaft is foldable, removable or retractable.

14. The wheelchair as claimed claim 1 in which the frame is foldable in the direction of the width.

15. The wheelchair as claimed in claim 1, in which the rear wheels (4) are detachable.

16. The wheelchair as claimed in claim 1, in which the rear wheels move from the lowered position to the raised position at the end of an angular travel of greater than or equal to 45°.

17. The wheelchair as claimed in claim 1, in which the rear wheels move from the lowered position to the raised position and at the end of an upward movement of greater than or equal to 8 cm, in the case of an angular travel of up to 60°.

18. The wheelchair as claimed in claim 1, in which the rear wheels move from the lowered position to the raised position at the end of a forward movement of greater than or equal to 4 cm, in the case of an angular travel of up to 60°.

19. The wheelchair as claimed in claim 1, in which the load-supporting elements (21) comprise crosses.

20. The wheelchair as claimed in claim 19, in which each cross comprises four mutually perpendicular arms.

21. The wheelchair as claimed in claim 20, in which the distance between the axis (W) of rotation of the front load-supporting elements and the axis (Y) of rotation of the rear wheels in the stairclimbing configuration is greater than or equal to 70 cm, and the distance between the axis (Y) of rotation of the rear wheels and the axis (X) of rotation of the rear load-supporting elements is greater than or equal to 50 cm, in the stairclimbing configuration.

22. The wheelchair as claimed in claim 1, in which the movement of the rear wheels from the lowered position to the raised position is done manually, without motorized assistance.

23. The wheelchair as claimed in claim 1, in which the rear wheels, in the raised position, are turned without motorized assistance.

24. The wheelchair as claimed in claim 5, in which each submechanism comprises a primary transmission shaft comprising two sets of teeth connected by transmission elements to corresponding sets of teeth rotating with the front and rear load-supporting elements, respectively.

25. The wheelchair as claimed in claim 24, in which the transmission elements comprise chains or at least one secondary transmission shaft having if desired at least one bevel gear set and/or at least one universal joint.

26. The wheelchair as claimed in claim 1, in which the propulsion mechanism comprises a hydraulic system having a pump operated by the rear wheels and hydraulic motors connected by a closed circuit to the pump and driving the front and rear load-supporting elements.

27. The wheelchair as claimed in claim 24, in which the primary transmission shaft rotates with a set of teeth meshing with an intermediate pinion, the corresponding rear wheel having an associated set of teeth that are able, when the rear wheel is in the raised position, to engage with the intermediate pinion in such a way as to transmit the rotary movement of the rear wheel to the load-supporting elements.
